(19) United States
(12) Patent Application Publication
(10) Pub. No.: US 2009/0202780 A1
(43) Pub. Date: Aug. 13, 2009

(54) FORMING A HONEYCOMB STRUCTURE

(75) Inventors: Raymond C. Loszewski, Windham, NH (US); Daniel P. DeSantis, Billerica, MA (US)

Correspondence Address: BAINWOOD HUANG & ASSOCIATES LLC, 2 CONNECTOR ROAD, WESTBOROUGH, MA, 01581, US

(73) Assignee: TEXTRON SYSTEMS CORPORATION, Wilmington, MA (US)

(21) Appl. No.: 12/366,823

(22) Filed: Feb. 6, 2009

Related U.S. Application Data
(60) Provisional application No. 61/028,403, filed on Feb. 13, 2008.

(51) Int. Cl. B32B 3/12; B32B 37/12

(52) U.S. Cl. 428/117; 156/196; 156/296

(57) ABSTRACT

Formation of a filled honeycomb structure by interleaving layers of material and pre-formed pins made of a desired filler material is disclosed. In one embodiment, the material layers may be pre-impregnated and the pre-formed pins may be made of a foam, insulating material. The fabric layers and the pre-formed elongated foam members are assembled in an interleaved manner to form a raw assembly, and heat is applied to activate the resin and cure the raw assembly. The technique further involves allowing the raw assembly to cool to form a unitary, integral honeycomb structure.

### CROSS REFERENCE TO RELATED APPLICATIONS

This Patent Application claims priority to U.S. Provisional Patent Application No. 61/028,403 filed on Feb. 13, 2008, entitled, “TECHNIQUES FOR FORMING A HONEYCOMB HEAT SHIELD STRUCTURE”, the contents and teachings of which are hereby incorporated by reference in their entirety.

### GOVERNMENT LICENSE

The U.S. Government has a paid-up license in this invention and the right in limited circumstances to require the patent owner to license others on reasonable terms as provided for by the terms of NNA07BC07C awarded by NASA.

### BACKGROUND

Honeycomb structures are utilized to meet design requirements for structural components that may be used in high temperature and highly stressed environments. As a structural core material, honeycomb can be used in different types of aerospace vehicles and supporting equipment. Honeycomb structures can be used to provide superior structural qualities, for example rigid panels of minimum weight; high heat shielding properties; aerodynamically smooth surfaces; and high fatigue resistant structures. The same structural properties are also used for commercial applications for example in tools, snow and water skis, bulkheads, and floors, to name a few. Honeycomb is also used where designs need directional air and/or fluid flow control and/or energy absorption.

One conventional aerospace application for honeycomb is to use it as a structural component of a heat shield, i.e. a fiberglass reinforced nylon phenolic honeycomb filled with Avcoat® insulation. “Avcoat” is the trade name for a mid-density, syntactic, silica-phenolic foam available from Textron Systems Corp. of Wilmington, Mass. In this application, the fiberglass reinforced nylon phenolic material defines a plurality of individual cells that form the honeycomb cell walls. Within each cell resides the Avcoat insulation. The Avcoat insulation is packed into the honeycomb matrix after it is attached to the carrier structure or substrate. The material is cured into a single monolithic article preferably without gaps.

Honeycomb can be manufactured using a variety of methods including expansion, corrugation and molding techniques. In the latter process, a layer of nylon phenolic material or prepreg is placed on a table having a series of precisely spaced parallel slots. Metal pins (or mandrels) having a hexagonal cross-section are then positioned over the prepreg layer and pushed into the slots so that the prepreg conforms to the contours of the table. The pins may be made of steel or aluminum and are preferably coated with a release agent to facilitate removal of the pins, as described below. The top surface of this first row of pins now replicates the surface profile of the original table. Next, another layer of prepreg is placed over the first row of metal pins and another row of pins is inserted into the slots formed by the underlying row of pins. Further pins and prepreg layers can be added in iterative fashion to build up the thickness of the overall honeycomb structure to whatever thickness is desired. Pressure and/or heat is then applied in order to consolidate and cure the structure. The pressure can be applied externally by means of a ram or other device or it may be generated from within due to thermal expansion while constrained. Once the curing process has been completed and the block has been cooled, the mandrel pins are removed from the block assembly. This operation is completed by hand with the occasional use of a hammer to knock the pins from the block to form a honeycomb structure with hexagonal cells. This honeycomb is cleaned to remove contaminants for subsequent bonding, e.g., filling each cell individually with ablative foam to form a heatshield.

The honeycomb structure is first cleaned by ultrasonic cleaning where each block is placed into a large ultrasonic cleaning tank in order to remove most of the contaminants, for example dust, oils, etc. and to prepare the structure for plasma cleaning. The honeycomb is thereafter plasma treated to remove residual surface contaminants, particularly within the cells. The plasma cleaning process removes, via ablation, organic contaminates such as the mold release that is applied to aid in the release of the metal pins. If the mold release is not removed, it can inhibit the bonding of materials, such as the Avcoat insulation to the honeycomb. The plasma cleaning also enhances the surface energy of the honeycomb structure thus increasing the ability to bond materials to the honeycomb.

After the honeycomb is cleaned, it is primed and the individual cells are manually filled with Avcoat insulation using a device similar to a caulking gun. The resulting structure, containing multiple cells filled with Avcoat insulation, is then manually inspected and X-rayed to confirm proper fabrication, particularly consistent density within the honeycomb matrix.

### SUMMARY

Although some foamed honeycomb materials are sold commercially, the majority of processes rely on filling the individual cells of prefabricated honeycomb with syntactic foam such as Avcoat 5026-39, or injecting multiple cells with expanding foam. These processes generally rely on post-filling of a prefabricated honeycomb, which is time consuming and manually intensive. Furthermore, the process based on molding requires manually inserting and removing the metal pins, as well as cleaning the cells, as described above. In addition, although generally effective, plasma cleaning may not remove 100% of the contaminants. In particular, plasma cleaning is more effective towards the outside surfaces of the honeycomb structure, and its effectiveness diminishes with depth towards the interior, especially if the cells are long and narrow.

If the individual cells are not thoroughly cleaned, the integrity of the adhesive bond with the filler may be compromised. In addition, any distortion of the honeycomb or in the gunning process for filling the individual cells can lead to density variations and associated rejects. In the conventional process for producing honeycomb filled with Avcoat 5026-39, there is about a 2%-4% rejection rate due to the above factors. Rejected cells are repaired by cutting out the section of damaged cells and replacing them with matching material. The “patch” is bonded to the honeycomb utilizing the same resin contained on the fabric. The repaired honeycomb is then re-cured and inspected once again. For a honeycomb structure containing about 300,000 cells, a 4% rejection rate results in the rejection of about 12,000 cells. At 1 hour of manpower per cell, this results in about 12,000 man-hours of time lost.

An improvement to the above-described conventional process involves forming the honeycomb structure around curable material pre-formed into pins that remain in place during heating to produce a unitary, molded structure. In one embodiment, this is accomplished by substituting preformed hexagonal pins made of foam insulation material, for example Avcoat 5026-39, in place of the metal pins that are currently used in the conventional process described above. As an option, these pins may be pre-coated with a primer to ensure that their surface is completely wetted prior to use. The preformed hexagonal Avcoat pins are placed between layers of the traditional nylon phenolic material. The assembly is then cured under heat and pressure and allowed to cool so that the resin within the prepreg layers sticks to the primer and/or the pins forming a unitary, bonded structure. In some arrangements, the assembly is heated at 1 atmosphere of pressure from a vacuum bagging operation to a temperature range between about 200 to about 250 degrees Fahrenheit to prevent overheating the insulating foam pins, which could adversely affect performance.

During this process, the foam insulation pins are bonded to the nylon phenolic cell walls, creating a unitary honeycomb structure that eliminates the need to remove the pins as in the prior art. The plasma cleaning of the cells to remove the mold release agent is also eliminated, as is the priming of the cells to receive the insulation and the manual injection of the foam insulation into individual cells. As will be appreciated, the reduction in the number and types of steps makes the process less manually intensive and less costly overall.

### BRIEF DESCRIPTION OF THE DRAWINGS

The foregoing and other objects, features and advantages will be apparent from the following description of particular embodiments of the invention, as illustrated in the drawings which are integrated within this document.

FIG. 1 is a schematic drawing of an exemplary honeycomb structure including empty cells and filled cells according to a first embodiment;

FIG. 2 is perspective view of the honeycomb structure of FIG. 1 with all cells illustrated filled with pre-formed pins;

FIG. 3 is a perspective view of an exemplary pre-formed pin of FIG. 1; and

FIG. 4 is a block diagram illustrating the process for forming a honeycomb structure with pre-formed pins.

### DETAILED DESCRIPTION

A process for forming a unitary, molded, multi-cell honeycomb structure that can be used in a variety of applications, for example as a heat shield or as structural members, is disclosed. The process involves the steps of laying up composite materials or preforms around pre-formed, curable foam members in honeycomb fashion and then curing the assembly to produce a unitary molded structure, as described in greater detail below. Such a process alleviates the need for burdensome, time-consuming steps such as inserting and removing metal pins, cleaning cells to remove any release agents, and manually injecting insulation into cells one at a time, as in conventional processes. It should be understood that the exemplary multi-cell honeycomb structure that is described herein utilizes hexagonal cells only as an example but the term “honeycomb” as used herein is not so limited and may have other geometric orientations.

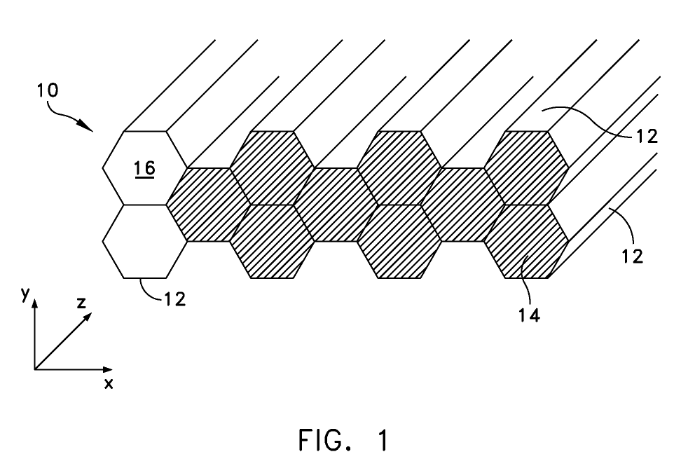

Referring now to FIG. 1, there is illustrated a diagram of a honeycomb structure 10 including two or more material layers 12 laid up around pre-formed, curable elongate members 14 that create a plurality of cells 16. For ease of illustration, not all the elongate members 14 are illustrated in the present figure so that the empty cells 16 that would be present if the elongate members were removed (e.g. as in the prior art) can be illustrated. The material layers 12 surround the elongate members 14 to form the cell walls of the honeycomb structure. The layers extend generally in the X and Z directions while the pre-formed elongate members extend generally in the Z direction. The type of material utilized for the layers 12 and for the elongate members 14 depends upon the particular application for the honeycomb structure.

In the present embodiment, the layers 12 are made of pre-impregnated fabric, for example a woven fiberglass that is saturated with a thermosetting resin that when cured produces a honeycomb structure used in heat shield applications. The fiberglass fabric is preferably pre-impregnated with a synthetic resin (e.g. nylon phenolic or epoxy) to form what is typically referred to as a woven prepreg. The prepreg is cut into sheets of the appropriate size and laid up around the elongate members so that once the assembly is heated to the appropriate temperature and pressure; the resin within the prepreg layers reacts, flows, and cures the assembly into a single, unitary structure. Alternatively, other types of materials may be utilized to form the honeycomb, depending upon the particular application. For example, the material may be unidirectional, non-woven, and even dry for impregnation after lay-up.

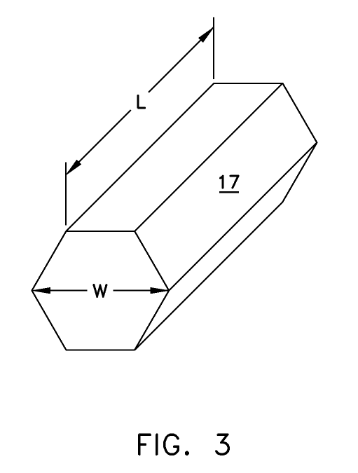

The elongate members 14 are made of a curable material, also depending upon the desired application. The elongate members are preformed into the particular shape and size for the application and may be surface treated or primed in order to promote adhesion during curing. For heat shield applications as illustrated in the present embodiment, the elongate members 14 may be pre-formed of foam insulation and may be made of Avcoat 5026-39, available commercially from Textron Systems Corp. of Wilmington, Mass. Additionally, the elongate members 14 may have a generally hexagonal shape, may be between about 7-10 inches long (“L”, FIG. 3) and have a width of about ⅜″ at their widest point (“W”). Alternatively, other geometries may be utilized as would be appreciated by one of skill in the art. In the present embodiment, the cross section of the elongate members is generally uniform, as illustrated in the drawings. However, in alternate embodiments curved sections of honeycomb structure may be formed by tapering at least some of the elongate members to correspond to the curvature in both the X and Y planes. Accordingly, the process is able to further comply with various custom requirements.

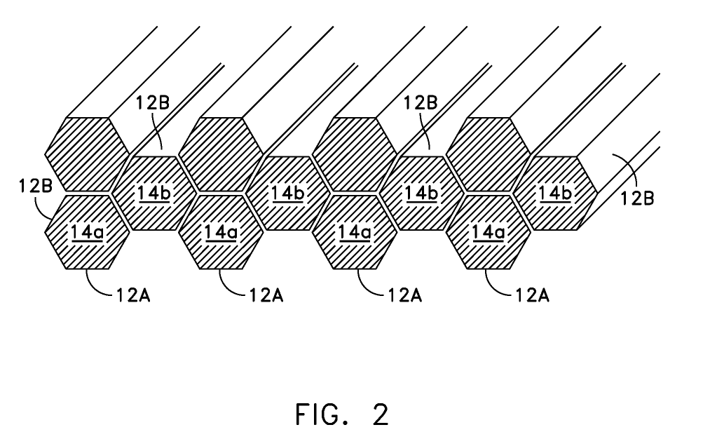

The elongate members 14 may be preformed into pins 14a, 14b (FIGS. 2-3) by machining the pins from a block stock of insulation Avcoat material, injection molding, or extruding the material, as desired. The pins may also be surface treated by plasma etching, grinding or otherwise roughening up the surface, or may be coated with a pre-treating agent or primer to promote adhesion to the honeycomb matrix material 12. Alternatively, the surface 17 of the pins may be left untreated. Once manufactured, the pins may be checked to ensure quality control prior to forming the honeycomb structure, for example by x-raying the pins to ensure acceptable density among the pins. By being able to inspect the density of the foam before curing the pins 14a, 14b with the layers 12 (e.g., fiberglass fabric impregnated with nylon phenolic resin), pins that do not have acceptable density can be rejected prior to insertion, thus improving the consistency of the final honeycomb structure and reducing the labor associated with repairing cells that do not have the required density. Once pre-formed and inspected the pins are ready to be assembled with the material layers to form the honeycomb structure.

To assemble the honeycomb structure, the pre-preg material layers 12 and the pre-formed foam pins 14a, 14b are interleaved to form a raw assembly in the present embodiment. For example, a first material layer 12a is laid up and a first set of foam pins 14a are placed onto the first layer (see FIG. 2). Then a second material layer 12b is laid over the first set of foam pins 14a. Thereafter, a second set of foam pins 14b are placed onto the second material layer 12b. Additional layers and pre-formed foam pins are laid over the existing layers to extend the assembly in the Y direction. The number of material layers 12 alternating with the corresponding pre-formed pins 14 again depends upon the particular application.

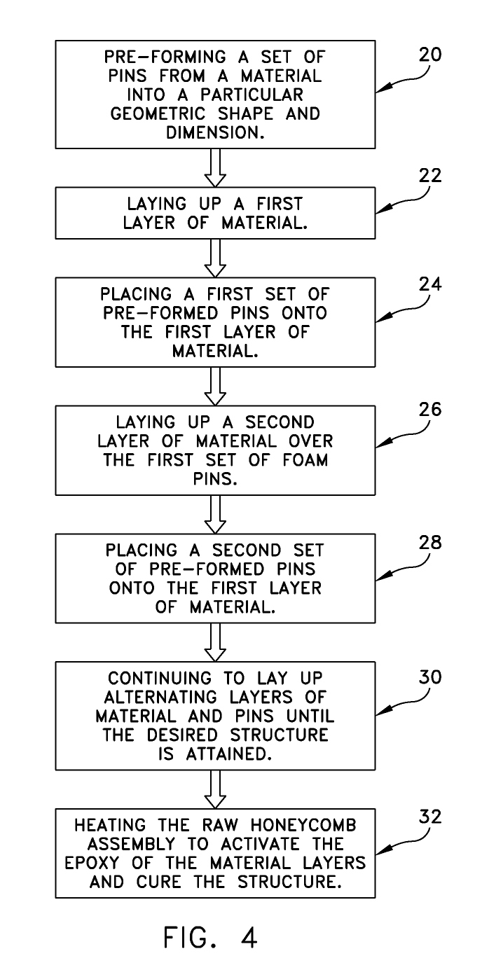

Once the desired numbers of alternating material layers 12a, b and pins 14a, 14b have been assembled, the raw assembly is constrained by a framework and placed in a pre-heated oven (e.g., 200 to 250 degrees Fahrenheit in the present embodiment) in order to activate the curing mechanism for the resin in the layers, and the structure is cured. Alternatively, the raw assembly is molded in a heated press, vacuum bag, autoclave or by any other means that is used in fabricating composites. The heating should not be overly high so as to not over-heat the pre-formed Avcoat pins. Once cooled, the structure is a unitary honeycomb, i.e. the material layers and pins are bonded together, and may be used as a heat shield structure. After the structure is formed it may be cleaned and inspected, as desired. The honeycomb can also be cut into a desired thickness according to the particular application, as would be known in the art. For heat shield applications, the honeycomb structure may be laid up into 10″ blocks that are thereafter cut down to a 2″-2½″ thickness in the Z direction (and several feet in the X and Y directions). The honeycomb structure can then be secured to the particular substrate. In the present embodiment, the bottom surface of the Avcoat honeycomb structure would thereafter be bonded to the substrate or substructure to form a heatshield for a space module. The overall process for forming the honeycomb structure will now be summarized with reference to FIG. 4.

As described above, the process of forming a honeycomb heat shield structure involves the steps of pre-forming a set of pins of a particular material and having a specific geometric shape and dimensions 20 according to the application. The pins may or may not be surface treated prior to assembling the structure to promote adhesion. A first layer of material 12A is placed on a surface or table (e.g., layers of nylon phenolic) 22 and a first set of pre-formed elongated members (e.g., pre-formed foam pins 14a) are placed onto the first layer of material 24. A second layer of material is then placed over the first set of pins in the next step 26. A second set of pins is thereafter placed onto the second layer of material 28. The process continues with alternating the fabric layers and the pre-formed elongated foam members to form a raw assembly 30. The raw assembly is then constrained and placed in an oven or heated press where the heat activates the resin of the fabric layers to allow the structure to cure 32. The epoxy may be any resinous matrix. The cure temp and time are defined by the specific materials used in the honeycomb core (e.g., 200 to 250 degrees Fahrenheit for Avcoat pins). The technique further involves allowing the raw assembly to completely cool to form a unitary, honeycomb structure.

It should be understood that, in contrast to conventional assembly approaches to inspecting and rejected honeycomb cells formed by filling empty cells defined by metal pins pre-coated with a release agent (e.g., reforming 12,000 cells of a 300,000 cell structure), the above-described techniques enable a manufacturer to easily inspect pins prior to assembling an insulative structure from foam pins. That is, the manufacturer initially provides general pin-shaped members (e.g., cuts pins from insulation stock, form pins using a mold, etc.), provides textured surfaces to the general pin-shaped members, i.e., remove any surface contaminants, provide high-precision dimensions, and prepares the surface for strong bonding with composite materials, etc. (a variety of texturing processes are suitable). The manufacturer is then able to individually inspect the foam pins for defects and reject non-conforming foam pins (e.g., X-ray each pin to detect defects beneath surfaces). Once the non-conforming foam pins have been removed from the process, the manufacturer is able to create a heat shield from conforming foam pins and honeycomb material (e.g., lay up prepreg materials and pins to build layers of the heat shield).

In some situations (e.g., when the designated heat shielded surface is non-planar), the manufacture is able to then hone the outer surfaces of heat shield to desired geometries and textures (e.g., add ridges to the mounting side of the heat shield to promote better adhesion with external bonding surface). The manufacturer is then able to fasten the mounting side of the heat shield to the external bonding surface (e.g., apply adhesive between the heat shield and the external bonding surface) for robust and reliable attachment.

While various embodiments of the invention have been particularly shown and described, it will be understood by those skilled in the art that various changes in form and details may be made therein without departing from the spirit and scope of the invention as defined by the appended claims.

For example, various resins may be used as an alterative to nylon phenolic such as polyimides, epoxies, cyanate ester, etc. In addition, alternate lightweight insulation materials or other fillers may be utilized with the honeycomb structure other than Avcoat. Furthermore, the honeycomb structure may be metallic instead of fiber reinforced polymer matrix. It should be understood that the geometry of the cells were described as having a hexagonal honeycomb structure by way of example only. A variety of shapes and sizes are suitable for use (e.g., hexagons, rectangles, circles, etc.) and the structure may be utilized in a variety of applications other than heat shielding.

What is claimed is:

1. A process for forming a multi-cell structure comprising:
pre-forming a set of elongated members having an outer surface with a pre-determined geometric shape;
placing a first layer of curable material on a surface;
placing a first set of the elongated members onto the first layer of curable material in a predetermined pattern;
placing a second layer of material over the first set of elongated members, wherein the first set of elongated members is sandwiched between the first layer of curable material and the second layer of curable material in order to enclose the outer surface of each of the first set of elongated members between the first and second layers;
continuing to place alternating layers of curable material and elongated members until a desired size assembly is achieved; and
heating and cooling the assembly including the curable material layers and elongated members to cure the assembly;
wherein a unitary, multi-cell structure including material layers and pre-formed elongated members bonded together is formed.

2. The process of claim 1, wherein the elongated members are pre-formed of a foam material.

3. The process of claim 2, wherein the elongated members are pre-formed of a syntactic foam.

4. The process of claim 1, further comprising treating the surface of the elongated members to promote adhesion between the layers of material and the elongated members.

5. The process of claim 4, wherein the treating the surface comprises roughening up the surface of the elongated members.

6. The process of claim 4, wherein treating the surface comprises coating the surface with a pre-treating agent to promote adhesion.

7. The process of claim 4, wherein the elongated members are pins.

8. The process of claim 4, wherein the pins have a hexagonal shape.

9. The process of claim 4, wherein the pins have a uniform cross-section.

10. The process of claim 1, wherein the material layers are pre-impregnated with an epoxy.

11. The process of claim 10, wherein pre-impregnated material layers are nylon phenolic.

12. The process of claim 1, further comprising inspecting the elongated members prior to placing the members onto the layers in order to compare density between the members.

13. The process of claim 1, wherein the unitary, multi-cell structure is a honeycomb structure.

14. A process for forming a multi-cell structure comprising:
pre-forming a set of foam members having an outer surface with a pre-determined geometric shape;
placing a first layer of a pre-impregnated curable material on a surface;
placing a first set of the foam members onto the first layer of pre-impregnated curable material in a predetermined pattern;
placing a second layer of pre-impregnated curable material over the first set of foam members, wherein the first set of foam members is sandwiched between the first layer of material and the second layer of material in order to enclose the outer surface of each of the first set of foam members between the first and second layers;
continuing to place alternating layers of pre-impregnated curable material and foam members until a desired size assembly is achieved; and
heating and cooling the assembly including the pre-impregnaged curable material layers and elongated members to cure the assembly;
wherein a unitary, multi-cell structure including material layers and pre-formed foam members bonded together is formed.

15. The process of claim 14, wherein the foam members are pre-formed of a syntactic foam.

16. The process of claim 14, further comprising treating the surface of the foam members to promote adhesion between the layers of material and the foam members.

17. The process of claim 16, wherein the treating the surface comprises roughening up the surface of the foam members.

18. The process of claim 16, wherein treating the surface comprises coating the surface with a pre-treating agent to promote adhesion.

19. The process of claim 16, wherein the foam members are elongated pins.

20. The process of claim 19, wherein the pins have a hexagonal shape.

21. The process of claim 19, wherein the pins have a uniform cross-section.

22. The process of claim 16, wherein the material layers are pre-impregnated with an epoxy.

23. The process of claim 16, wherein pre-impregnated material layers are nylon phenolic.

24. The process of claim 16, further comprising inspecting the elongated members prior to placing the members onto the layers in order to compare density between the members.

25. The process of claim 14, wherein the unitary, multi-cell structure is a honeycomb structure.

26. A process for forming a honeycomb structure comprising:
pre-forming a set of foam pins having an outer surface with a pre-determined geometric shape;
placing a first layer of fabric material pre-impregnated with a resin on a surface;
placing a first set of the foam pins onto the first layer of pre-impregnated fabric material in a predetermined pattern;
placing a second layer of pre-impregnated fabric material over the first set of foam pins, wherein the first set of foam pins is sandwiched between the first layer of fabric material and the second layer of fabric material in order to enclose the outer surface of each of the first set of foam pins between the first and second layers;
continuing to place alternating layers of pre-impregnated fabric material and foam pins until a desired size assembly is achieved; and
heating the pre-impregnaged fabric material layers and elongated members to a temperature sufficient to cause the resin to flow;
curing the assembly including the layers of fabric material and foam pins;
wherein a unitary, multi-cell honeycomb structure including fabric layers and pre-formed foam members bonded together is formed.

27. An insulative member, comprising:
a foam pin which is formed from a hardened curable material that is cut, textured and inspected, the foam pin geometrically defining (i) a direction of pin elongation and (ii) a cell shape to fit as a cell among other similarly-shaped and co-aligned foam pins in a multi-cell formation which forms an integrated insulative shield that extends in a planar manner in directions substantially perpendicular to the direction of pin elongation.

28. An insulative assembly, comprising:
a meshing material; and
foam pins supported by and in contact with the meshing material;
each foam pin being pre-formed from a hardened curable material that is cut, textured and inspected;
each foam pin geometrically defining (i) a direction of pin elongation and (ii) a cell shape to fit as a cell among neighboring co-aligned foam pins in a multi-cell formation while supported by and in contact with the meshing material; and
the foam pins being co-aligned and cured with the meshing material to form an integrated insulative shield that extends in a planar manner in directions substantially perpendicular to the direction of pin elongation defined by the co-aligned foam pins.
